(19) United States
(12) Patent Application Publication
(10) Pub. No.: US 2016/0170735 A1
(43) Pub. Date: Jun. 16, 2016

(54) OPERATING SYSTEM UPDATING METHOD BY USING A CHECKLIST

(71) Applicant: QISDA CORPORATION, Taoyuan City (TW)

(72) Inventor: Min-An Kuo, Hsinchu City (TW)

(21) Appl. No.: 14/930,661

(22) Filed: Nov. 3, 2015

(30) Foreign Application Priority Data
Dec. 11, 2014 (TW) 103143331

(51) Int. Cl. G06F 9/445; G06F 11/14; H04L 29/08

(52) U.S. Cl. CPC G06F 8/65; H04L 67/34; G06F 11/1464; G06F 2201/84

(57) ABSTRACT

An operating system updating method includes linking a device to a server for checking whether a second operating system is on the server; downloading a checklist to the device if the second operating system is on the server; checking whether a current recovery image file conforms to the checklist; replacing the current recovery image file with a backup recovery image file if the current recovery image file fails to conform to the checklist; checking whether a set of system data files of the device conforms to the checklist; downloading a full updating package of files corresponding to the second operating system to the device from the server if the set of system data files fails to conform to the checklist; and installing the second operating system on the device for replacing the first operating system by using the backup recovery image file and the full updating package of files.

### CROSS REFERENCE TO RELATED APPLICATION

This application claims priority to Taiwan Patent Application No. 103143331, filed Dec. 11, 2014, and incorporated herein by reference in its entirety.

### BACKGROUND OF THE INVENTION

1. Field of the Invention

The present application relates to an operating system updating method, and more particularly, an operating system updating method by using a checklist.

2. Description of the Prior Art

A prior art operating system of a device is able to perform automatic update after the device is linked to a server. For example, firmware over-the-air (FOTA) method is widely used for updating an operating system of a mobile device (e.g. cellphone) automatically. FIG. 1 illustrates a flowchart of an operating system updating method 100 according to prior art. After a device is linked to a server in step 110, for example, a cellphone is linked to a server via Wi-Fi (Wireless Fidelity) network, it is checked whether the server has released an operating system of a newer version in step 120. If the operation system of a newer version is on the server, an updating package of files is downloaded in step 130, and the operating system of the newer version is installed on the device by using the downloaded updating package of files, and a set of system data files and a recovery image file stored in the device. However, if a user has performed a software modification (e.g. so-called rooting operation) on the device, the system data files and the recovery image file may be modified, causing failure in the operating system updating operation and poor user experience.

### SUMMARY OF THE INVENTION

An embodiment of the present application discloses an operating system updating method for replacing a first operating system of a device. The method includes linking the device to a server; downloading a checklist to the device from the server when the second operating system is available on the server; checking a current recovery image file of the device with the checklist; replacing the current recovery image file with a backup recovery image file when the current recovery image file fails to conform to the checklist; checking a set of system data files of the device with the checklist; downloading an updating package of files corresponding to a part of updating files of the second operating system to the device from the server if the set of system data files conforms to the checklist; and installing the second operating system on the device for replacing the first operating system of the device by using the backup recovery image file, the updating package of files and the set of system data files.

Another embodiment of the present application discloses an operating system updating method for replacing a first operating system of a device. The method includes linking the device to a server; downloading a checklist to the device from the server when the second operating system is available on the server; checking a current recovery image file of the device with the checklist; checking a set of system data files of the device with the checklist when the current recovery image file conforms to the checklist; downloading an updating package of files corresponding to a part of updating files of the second operating system to the device from the server when the set of system data files conforms to the checklist; and installing the second operating system on the device for replacing the first operating system of the device by using the current recovery image file, the updating package of files and the set of system data files.

Another embodiment of the present application discloses an operating system updating method for replacing a first operating system of a device. The method includes linking the device to a server; downloading a checklist to the device from the server if the second operating system is available on the server; checking a current recovery image file of the device with the checklist; replacing the current recovery image file with a backup recovery image file when the current recovery image file fails to conform to the checklist; checking a set of system data files of the device with the checklist; downloading a complete updating package of files corresponding to the second operating system to the device from the server when the set of system data files fails to conform to the checklist; and installing the second operating system on the device for replacing the first operating system of the device by using the backup recovery image file and the complete updating package of files.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of an operating system updating method according to prior art.

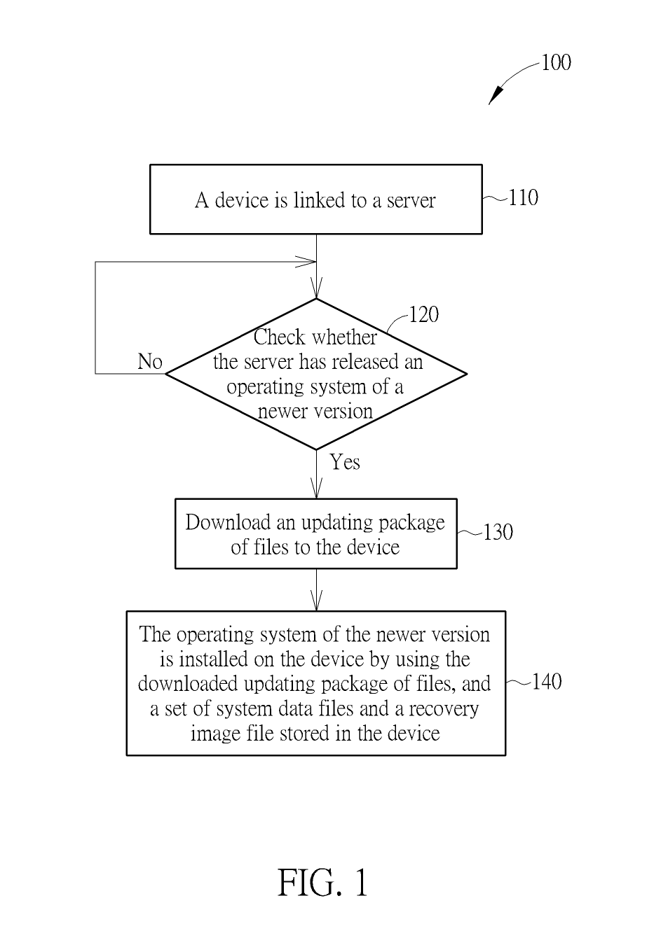

FIG. 2 illustrates a flowchart of an operating system updating method according to an embodiment of the present invention.

FIG. 3 illustrates the link between a device and a server and related files according to an embodiment of the present invention.

FIG. 4 illustrates the link between a device and a server and related files according to another embodiment of the present invention.

FIG. 5 illustrates the link between a device and a server and related files according to another embodiment of the present invention.

FIG. 6 illustrates the link between a device and a server and related files according to another embodiment of the present invention.

FIG. 7 illustrates the checklist according to an embodiment of the present invention.

### DETAILED DESCRIPTION

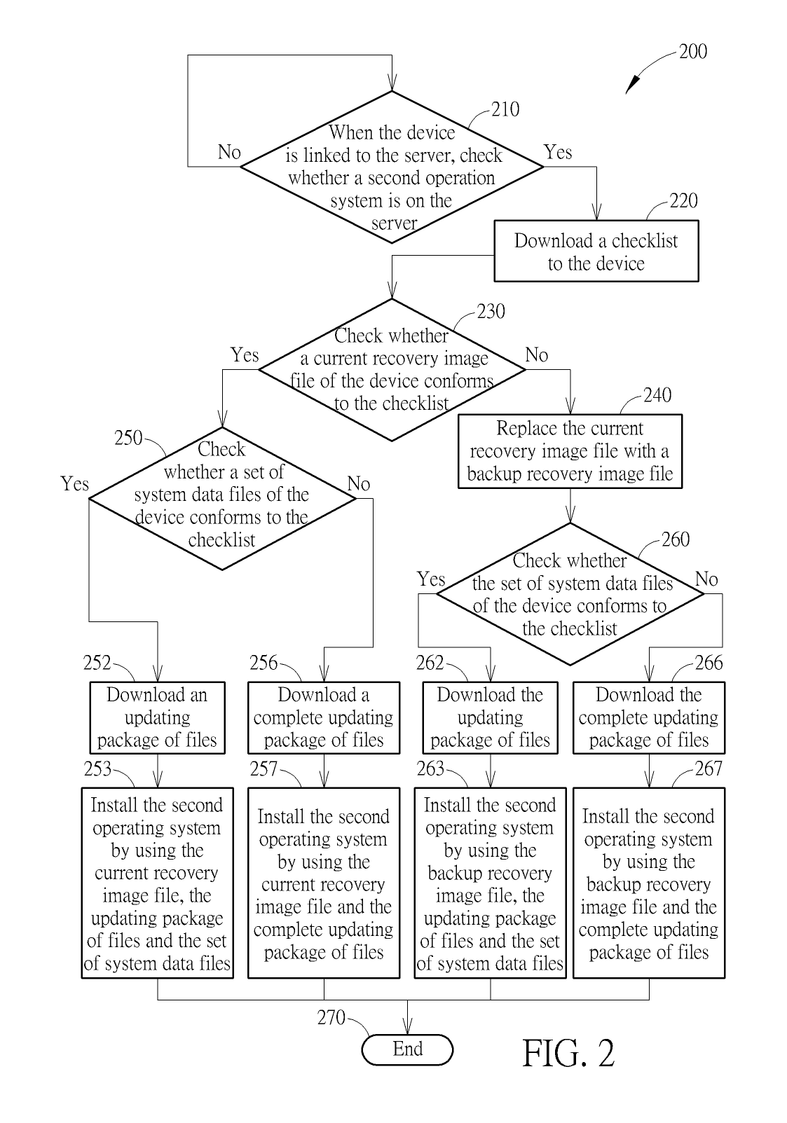

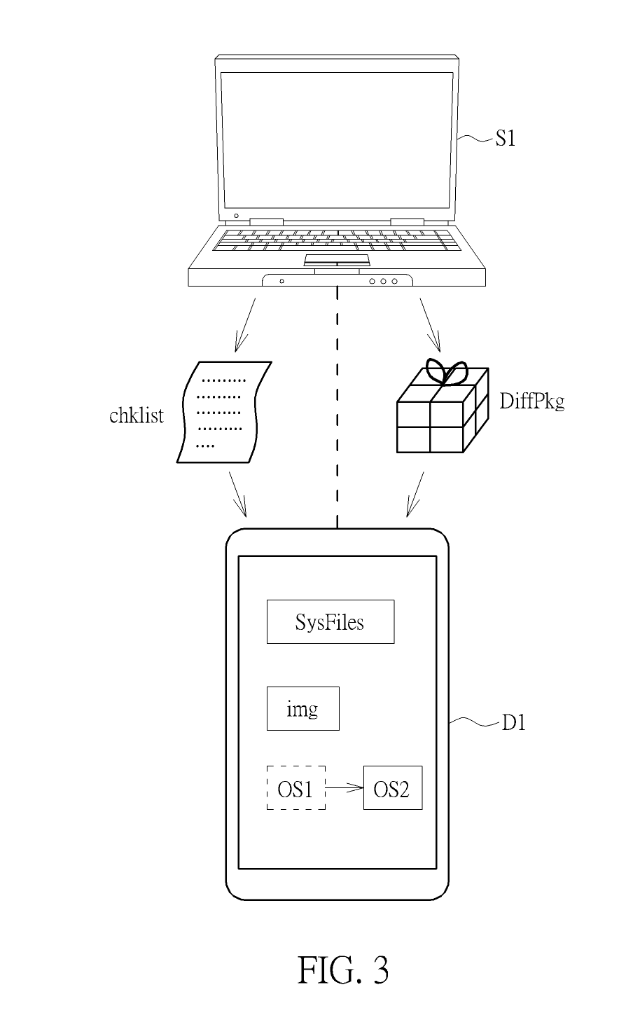

FIG. 2 illustrates a flowchart of an operating system updating method 200 according to an embodiment of the present invention. FIGS. 3-6 illustrate the link between a device D1 and a server S1 and related files according to embodiments of the present invention.

A first operation system OS1 has been installed on the device D1, and the operating system updating method 200 is used for updating the operation system on D1 automatically. The method 200 may include the following steps.

Step 210: when the device D1 is linked to the server S1, check whether a second operation system OS2 is available on the server S1; if so, go to step 220; else go to step 210;

Step 220: download a checklist chklist to the device D1 from the server S1; go to step 230;

Step 230: check whether a current recovery image file img of the device D1 conforms to the checklist chklist; If so, go to step 250; else go to step 240;

Step 240: Replace the current recovery image file img with a backup recovery image file imgBackup; go to step 260;

Step 250: check whether a set of system data files SysFiles of the device D1 conforms to the checklist chklist; if so, go to step 252; else go to step 256;

Step 252: download an updating package of files DiffPkg to the device D1; go to step 253;

Step 253: install the second operating system OS2 on the device D1 for replacing the first operating system OS1 of the device D1 by using the current recovery image file img, the updating package of files DiffPkg and the set of system data files SysFiles; go to step 270;

Step 256: download a complete updating package of files FullPkg to the device D1; go to step 257;

Step 257: install the second operating system OS2 on the device D1 for replacing the first operating system OS1 of the device D1 by using the current recovery image file img and the complete updating package of files FullPkg; go to step 270;

Step 260: check whether the set of system data files SysFiles of the device D1 conforms to the checklist chklist; if so, go to step 262; else go to step 266;

Step 262: download the updating package of files DiffPkg to the device D1; go to step 263;

Step 263: install the second operating system OS2 on the device D1 for replacing the first operating system OS1 of the device D1 by using the backup recovery image file imgBackup, the updating package of files DiffPkg and the set of system data files SysFiles; go to step 270;

Step 266: download the complete updating package of files FullPkg to the device D1; go to step 267;

Step 267: install the second operating system OS2 on the device D1 for replacing the first operating system OS1 of the device D1 by using the backup recovery image file imgBackup and the complete updating package of files FullPkg; go to step 270;

Step 270: end.

The aforementioned device D1 may be a cell phone, a tablet computer, a home computer or a smart home appliance. In step 210, for example, the device D1 may be linked to the server S1 when a cell phone is linked to a Wi-Fi network, a 3G (third generation) network or an LTE (Long Term Evolution) network. The cell phone (acting as the device D1) may be linked to a remote server (acting as the server S1) via the network. After the link is built, it may be checked whether the second operating system OS2 for update is ready on the server S1 automatically. For example, if the first operating system OS1 installed on the device D1 is Android 4.4-Kitkat, check whether the server S1 has a more recent version of Android operating system for update. When a second operating system OS2 (e.g. Android 5.0-Lollipop which is newer than Android 4.4-Kitkat) is available on the server S1 for update, the checklist chklist is downloaded in step 220. If there is no newer version for update, step 210 may be performed again to check again. The frequency for performing the checking operations in step 210 may be set in a virtual device server of the device D1 such as a Firmware Over The Air (FOTA) server. The frequency may, for example, be once every day or be whenever the device D1 is linked to the server S1.

In step 230, after downloading the checklist chklist to the device D1, the storage location and the content of the current recovery image file img may be checked according to the checklist chklist. If the result shows that the current recovery image file img conforms to the checklist chklist, the current recovery image file img need not be updated and step 250 can be performed. If the result shows that the current recovery image file img fails to conform to the checklist chklist, step 240 is performed to replace the incorrect current recovery image file img with the backup recovery image file imgBackup. The backup recovery image file imgBackup may be stored on the device D1, downloaded from the server S1 or stored in a storage space of an external memory card (e.g. an SD card) allowed to be inserted into a socket of the device D1. The function of the backup recovery image file imgBackup is described later.

In steps 250 and 260, it is checked whether the set of system data files SysFiles of the device D1 conforms to the checklist chklist, the check items may include checking file paths and checking file content. Taking Android system for example, when updating operating system, a plurality of system files (which may be in apk format) stored in a directory named “system” are system files which must be executed when updating the operating system. If the result of step 250 or step 260 shows that the set of system data files SysFiles conforms to the checklist chklist, implying that the set of system data files SysFiles can be used for installing the second operating system OS2, it merely needs to perform step 252 or step 262 to download the updating package of files DiffPkg with a smaller size. The updating package of files DiffPkg may correspond to a part of updating files of the second operating system OS2. However, if the result of checking of step 250 or step 260 shows that the set of system data files SysFiles fails to conform to the checklist chklist, implying that files of the set of system data files SysFiles may be lost, damaged or dislocated in incorrect paths so that the set of system data files SysFiles cannot be used when installing the second operating system OS2, then step 256 or step 266 needs to be performed to download the complete updating package of files FullPkg for installing the second operating system OS2. Comparing with the updating package of files DiffPkg, the complete updating package of files FullPkg is of a larger size and has a more complete content.

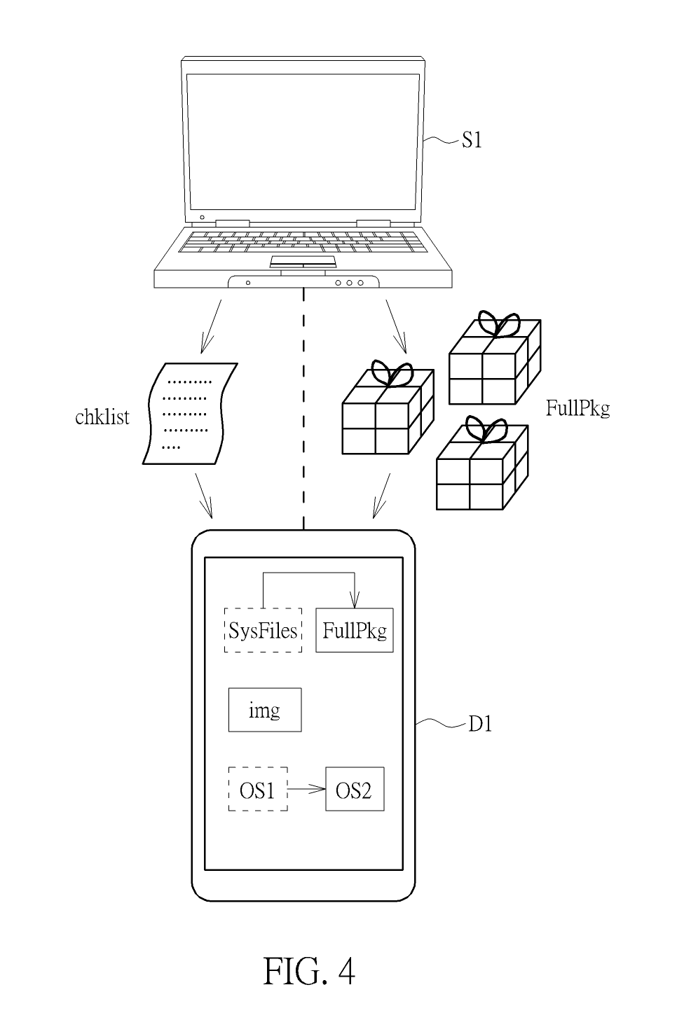

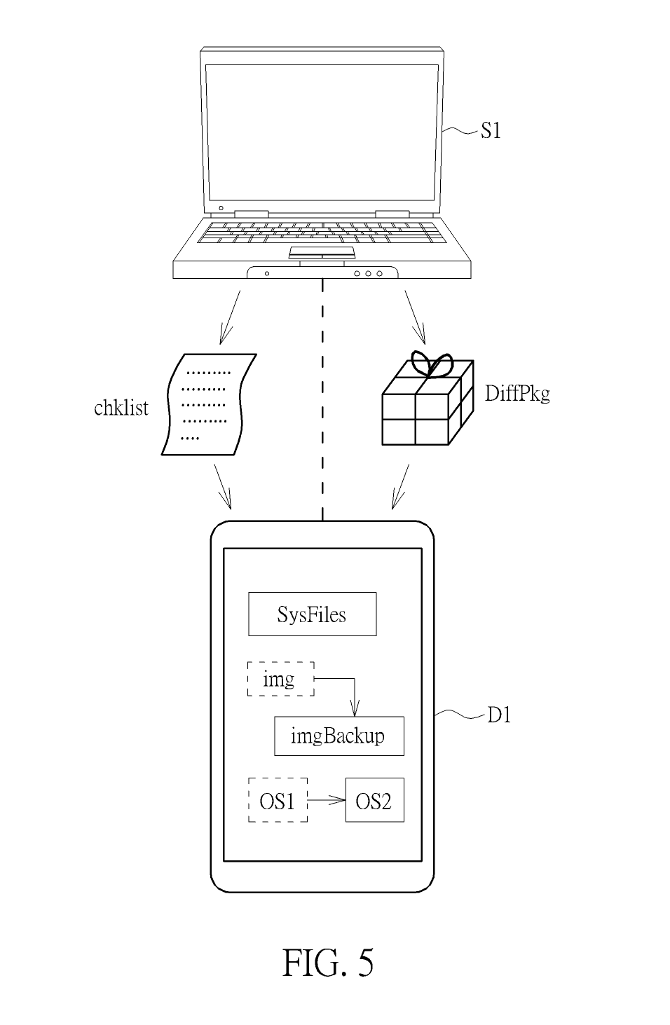

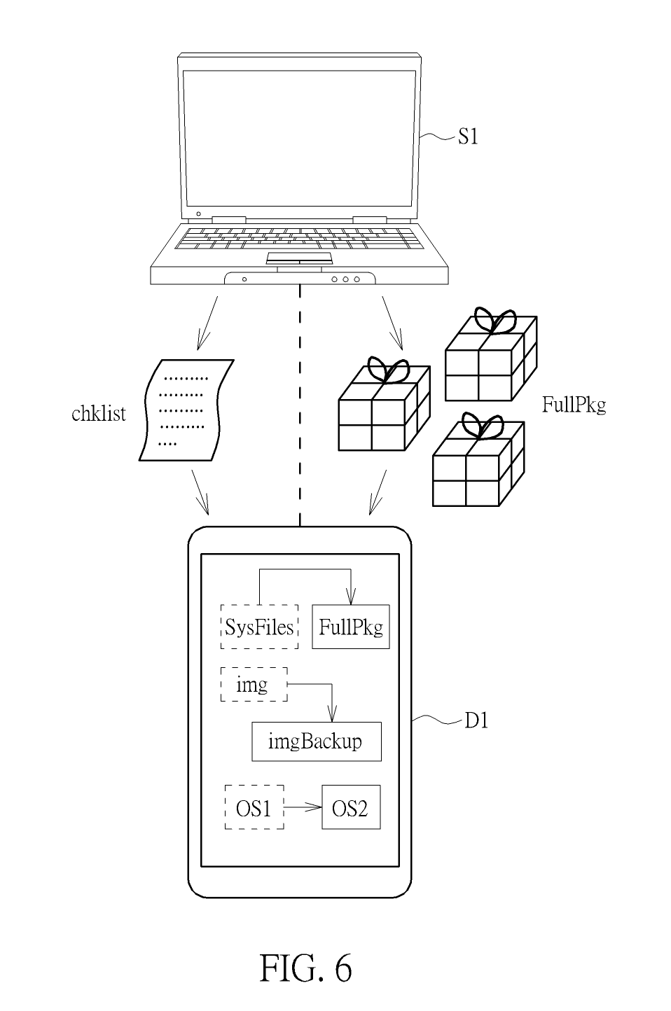

FIGS. 3-6 illustrate the link and data transfer between the server S1 and the device D1 according to embodiments of the present invention. FIG. 3 corresponds to steps 252-253 of the flowchart of FIG. 2. FIG. 4 corresponds to steps 256-257 of the flowchart of FIG. 2. FIG. 5 corresponds to steps 262-263 of the flowchart of FIG. 2. FIG. 6 corresponds to steps 266-267 of the flowchart of FIG. 2.

Taking steps 252-253 and FIG. 3 for example, since the current recovery image file img and the set of system data files SysFiles both conform to the checklist chklist, the following files may be used to install the second operating system OS2 on the device D1:
(1) the current recovery image file img;
(2) the updating package of files DiffPkg; and
(3) the set of system data files SysFiles.

The details of the installation may be as follows. After downloading the updating package of files DiffPkg to the device D1 in step 252, the device D1 may be rebooted with a configuration set in the current recovery image file img to enter a recovery mode so as to execute programs written in the updating package of files DiffPkg and the set of system data files SysFiles to install the second operating system OS2 on the device D1. Taking Android system for example, the famous Android update screen with an Android little green man rotating may be shown on the screen when performing step 253 for installing the second operating system OS2. After finishing installing the second operating system OS2, the device D1 may be rebooted again to enter a normal mode so as to start working under the second operating system OS2.

Taking steps 266-267 and FIG. 6 for example, since the current recovery image file img fails to conform to the checklist chklist in step 230, the current recovery image file img is replaced with the backup recovery image file imgBackup in step 240. Furthermore, since the set of system data files SysFiles fails to conform to the to the checklist chklist in step 260, the complete updating package of files FullPkg of a larger size (than the updating package of files DiffPkg) is downloaded to the device D1 in step 266 so that the second operating system OS2 may be installed with the following files in step 267:
(1) the backup recovery image file imgBackup; and
(2) the complete updating package of files FullPkg.

The details of the installation may be similar to description above. The backup recovery image file imgBackup may be used to reboot the device D1 to enter the recovery mode. In the recovery mode, programs of the complete updating package of files FullPkg (that may be written in a plurality of program files in apk format) may be executed for installing the second operating system OS2.

The operation of the embodiments illustrated in FIG. 4 (corresponding to steps 256-257) and FIG. 5 (corresponding to steps 262-263) is similar to the description above. That is to say, the backup recovery image file imgBackup is used to replace the current recovery image file img when the current recovery image file img fails to conform to the checklist chklist, and the complete updating package of files FullPkg is downloaded when the set of system data files SysFiles fails to conform to the checklist chklist. Hence, it is not described repeatedly. Regarding the first and second operating systems OS1 and OS2, the second operating system OS2 may be of a newer version or an older version than the first operating system OS1, or of a version identical to the first operating system OS1. Moreover, each time of updating the operating system may be recorded in a log file for verification or debugging afterward.

In prior art, the file content and file paths of the current recovery image file img and the set of system data files SysFiles are assumed to be complete and correct, so the updating package of files DiffPkg would be downloaded directly for using the current recovery image file img, the set of system data files SysFiles and the updating package of files DiffPkg to install the second operating system of updated version. However, since more and more users would like to modify the operating system by so-called rooting operation, the current recovery image file img and/or the set of system data files SysFiles are likely to be lost or damaged during the rooting operation. The automatic update of the operating system according to prior art may therefore fail and lead to users' inconvenience. Another method with higher success rate is to download the aforesaid complete updating package of files FullPkg whenever the device D1 is linked to the server S1 and the second operating system OS2 is detected to be ready on the server S1. However, since the updating package of files DiffPkg may have a size of ten megabyte, and the complete updating package of files FullPkg may have a size of hundreds of megabyte, the sizes of the two packages of files are of great disparity. If the complete updating package of files FullPkg is always downloaded whenever the operating system is updated, great amount of download time and network bandwidth are required. According to an embodiment, the checklist chklist is used to check the current recovery image file img and the set of system data files SysFiles so as to determine whether the current recovery image file img is to be replaced by the backup recovery image file imgBackup or not, and to determine which of the updating package of files DiffPkg and the complete updating package of files FullPkg is to be downloaded.

Since the complete updating package of files FullPkg may have a data size of hundreds of megabytes, before downloading the complete updating package of files FullPkg in steps 256 and 266, a message may prompt a user to confirm if the complete updating package of files FullPkg is to be downloaded to the device D1. The complete updating package of files FullPkg may not be downloaded without the user's approval.

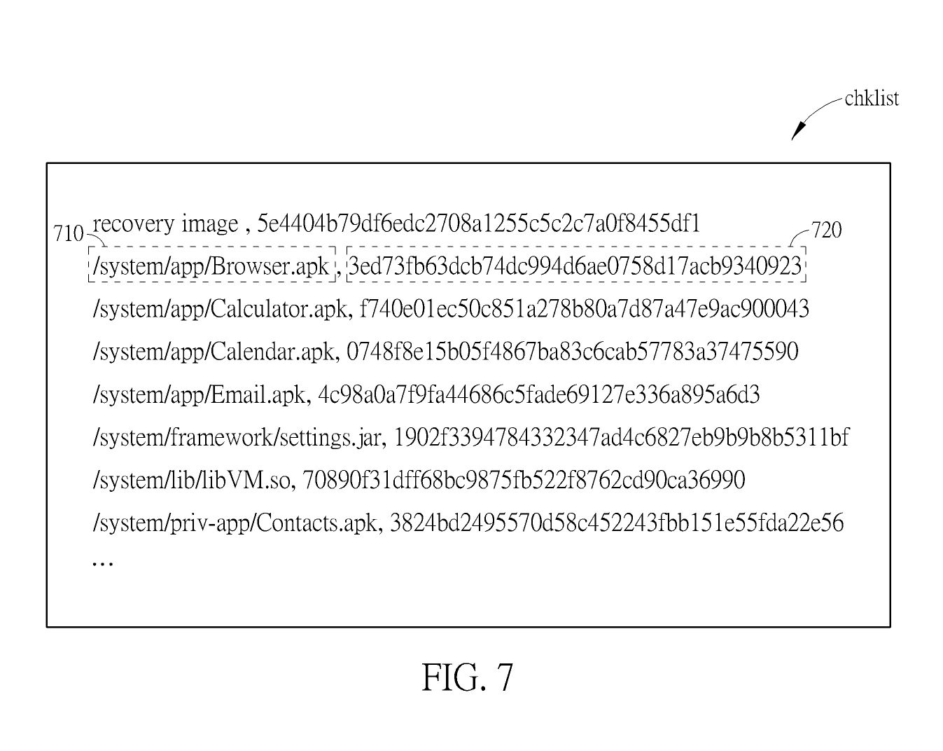

FIG. 7 illustrates the checklist chklist according to an embodiment of the present application. According to the embodiment of the present application, the checklist chklist may be a text file recorded with storage paths and check codes of files. Referring to FIG. 5, the first line of checklist chklist illustrated in FIG. 7 may be used for checking the current recovery image file img, and the following lines of checklist chklist may be used for checking the set of system data files SysFiles. Taking the second line for example, the file path 710 “/system/app/Browser.apk” records the correct file path of a file “Browser.apk” of the set of system data files SysFiles, and a check code 720 is corresponding to the file “Browser.apk”. The format of the check code 720 may be (but not limited to) a secure hash algorithm format such as SHA-1 format. When checking the file, the checked file (e.g. Browser.apk in FIG. 7) may be calculated with a secure hash algorithm so as to generate an SHA-1 code, and the generated SHA-1 code may be used to compare with the check code 720. If the file storage path of the checked file “Browser.apk” in the device D1 conforms to the file path 710, and the corresponding SHA-1 code generated by using the file “Browser.apk” conforms to the check code 720, it may be considered that the checked file “Browser.apk” conforms to the second line of the checklist chklist correctly. Likewise, it may be checked whether the recovery image file img is stored in a correct file path, and whether a SHA-1 code generated by calculating the recovery image file img is identical to a corresponding check code according to the checklist chklist. According to the checklist chklist, it may be also allowed to check whether the device D1 has the set of system data files SysFiles in corresponding system folders and check whether a check code of each of the system data files SysFiles is correct. The operation performed in steps 230, 250 and 260 for checking the recovery image file img and the set of system data files SysFiles may be as described above to check whether file paths and file data are correct.

In summary, by means of the operating system updating method disclosed by embodiments of the present application, users who damaged or lost the recovery image file and/or the set of system data files after trying to root the device can restore the recovery image file and/or the set of system data files easily. Users may determine whether the operating system is to be updated continually, and can save network bandwidth by updating the operating system with a smaller updating package of files. Even if the set of system data files is damaged so that the complete updating package of files needs to be downloaded, users merely need to wait for a longer time rather than suffering the failure of updating the operating system that would occur in the prior art. Hence, the embodiments overcome problems of prior art and can improve user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An operating system updating method configured to replace a first operating system of a device, the method comprising:
linking the device to a server;
downloading a checklist to the device from the server when a second operating system is available on the server;
checking a current recovery image file of the device with the checklist;
replacing the current recovery image file with a backup recovery image file when the current recovery image file fails to conform to the checklist;
checking a set of system data files of the device with the checklist;
downloading an updating package of files corresponding to a part of updating files of the second operating system to the device from the server when the set of system data files conforms to the checklist; and
installing the second operating system on the device for replacing the first operating system of the device by using the backup recovery image file, the updating package of files and the set of system data files.

2. The operating system updating method of claim 1, wherein checking whether the current recovery image file of the device conforms to the checklist comprises:
checking whether the current recovery image file is located in an image file path of the device according to the checklist; and
checking whether a check code corresponding to the current recovery image file is correct according to the checklist.

3. The operating system updating method of claim 1, wherein the backup recovery image file is stored on the device, the server or a storage space of an external memory card allowed to be inserted into a socket of the device.

4. The operating system updating method of claim 1, wherein checking whether the set of system data files of the device conforms to the checklist comprises:
checking whether the set of system data files are in corresponding system folders according to the checklist; and
checking whether a check code of each of the system data files is correct according to the checklist.

5. The operating system updating method of claim 1, wherein the second operating system is of a new version or a version identical to the first operating system.

6. The operating system updating method of claim 1, wherein the second operating system is of an older version than a version of the first operating system.

7. An operating system updating method configured to replace a first operating system of a device, the method comprising:
linking the device to a server;
downloading a checklist to the device from the server when the second operating system is available on the server;
checking a current recovery image file of the device with the checklist;
checking a set of system data files of the device with the checklist when the current recovery image file conforms to the checklist;
downloading an updating package of files corresponding to a part of updating files of the second operating system to the device from the server when the set of system data files conforms to the checklist; and
installing the second operating system on the device for replacing the first operating system of the device by using the current recovery image file, the updating package of files and the set of system data files.

8. The operating system updating method of claim 7, wherein checking whether the current recovery image file of the device conforms to the checklist comprises:
checking whether the set of system data files are in corresponding system folders according to the checklist; and
checking whether a check code of each of the system data files is correct according to the checklist.

9. The operating system updating method of claim 7, wherein checking whether the current recovery image file of the device conforms to the checklist comprises:
checking whether the current recovery image file is located in an image file path of the device according to the checklist; and
checking whether a check code corresponding to the current recovery image file is correct according to the checklist.

10. The operating system updating method of claim 7, wherein the second operating system is of a newer version or a version identical to the first operating system.

11. The operating system updating method of claim 7, wherein the second operating system is of an older version than the first operating system.

12. An operating system updating method configured to replace a first operating system of a device, the method comprising:
linking the device to a server;
downloading a checklist to the device from the server if the second operating system is available on the server;
checking a current recovery image file of the device with the checklist;
replacing the current recovery image file with a backup recovery image file when the current recovery image file fails to conform to the checklist;
checking a set of system data files of the device with the checklist;
downloading a complete updating package of files corresponding to the second operating system to the device from the server when the set of system data files fails to conform to the checklist; and
installing the second operating system on the device for replacing the first operating system of the device by using the backup recovery image file and the complete updating package of files.

13. The operating system updating method of claim 12, wherein checking whether the set of system data files of the device conforms to the checklist comprises:
checking whether the set of system data files are in corresponding system folders according to the checklist; and
checking whether a check code of each of the system data files is correct according to the checklist.

14. The operating system updating method of claim 12, wherein checking whether the current recovery image file of the device conforms to the checklist comprises:
checking whether the current recovery image file is located in an image file path of the device according to the checklist; and
checking whether a check code corresponding to the current recovery image file is correct according to the checklist.

15. The operating system updating method of claim 12, wherein the backup recovery image file is stored on the device, the server or a storage space of an external memory card allowed to be inserted into a socket of the device.

16. The operating system updating method of claim 12, wherein the second operating system is of a newer version or a version identical to the first operating system.

17. The operating system updating method of claim 12, wherein the second operating system is of an older version than the first operating system.
